(19) United States
(12) Patent Application Publication
(10) Pub. No.: US 2025/0130362 A1
(43) Pub. Date: Apr. 24, 2025

(54) SYSTEMS AND METHODS FOR SENSOR INSTRUMENTATION IN NUCLEAR REACTORS

(71) Applicant: GE-Hitachi Nuclear Energy Americas LLC, Wilmington, NC (US)

(72) Inventors: Bahman Zohuri, San Mateo, CA (US); Mark A. Sapia, Canton, CT (US); James J. Cushenberry, Wilmington, NC (US); Fnu Krishichayan, Durham, NC (US); Herbert F. Butler, III, Wilmington, NC (US)

(21) Appl. No.: 18/383,306

(22) Filed: Oct. 24, 2023

(51) Int. Cl. G02B 6/02; G01K 11/32; G01N 21/63; G21C 17/108; G21C 17/112

(52) U.S. Cl. CPC G02B 6/021; G01K 11/32; G01N 21/63; G21C 17/108; G21C 17/112

(57) ABSTRACT

Arrays are configured to detect temperatures, radiation levels, strain, seismic vibrations, water levels, and other physical characteristics and report the same by transmission of electromagnetic radiation along a carrier fiber. No associated thermal mass may be required; the fiber itself may scatter or emit light in amounts, frequencies, intervals, etc. that directly indicate the characteristics. The arrays are useable in remote and inhospitable conditions and may report data over kilometers. Luminescence or scattering like Raman, Rayleigh, or Brilliouin scattering may cause the emission or scattering, and a computerized interpreter may detect the light and associate it with the characteristics for output to a user. Silica, silicon dioxide, quartz, acrylate, silicone, fluoropolymers, sapphire, rare earth elements, halogens, boron, germanium oxides, carbon-doped aluminum oxide are all useable for this effect, potentially at several hundred degrees Celsius without failure.

### BACKGROUND

FIG. 1 illustrates a related art system for measuring gamma flux at multiple locations in a nuclear core with optical gamma thermometers and optical fiber cables. U.S. Pat. No. 8,503,599 to Koste et al. disclose similar systems for nuclear reactor monitoring elements and is incorporated herein by reference in its entirety. The system of FIG. 1 may include strings S having multiple optical gamma thermometers 30 in each string S with materials that heat in association with gamma flux, and sensors with those materials to detect and report the temperature. Optical gamma thermometers 30 may include fiber Bragg grating (FBG) structures 42 to measure the temperature of another gamma-sensitive material, such as an associated metal mass, at discrete locations in the reactor core. An interrogator, such as a FBG interrogator, in optical communication with an optical splitter or switch includes a light source and a light receiver and a processor and communications unit. The interrogator is in communication with a network interface for transmitting data to a processor 68, such as a laptop computer, and the like, potentially via wireless interface 67.

FIG. 2 is an illustration of a related art string S of gamma thermometers 30 from FIG. 1, using optical fiber cable 32 for string S. As shown in FIG. 2, optical fiber cable 32 includes central fiber core 38 formed of pure or doped silica that extends along a long axis 33 and having a diameter of about 5 microns to about 100 microns. Fiber cable 32 includes a periodic modulated refractive index profile along the long axis 33, such as a cosine or Gaussian apodized refractive index profile. Fiber cladding 40 circumferentially covers fiber core 38 and has an outer diameter of about 125 microns made from pure or doped silica. Fiber core 38 has a higher index of refraction than the fiber cladding 40 such that fiber cable 32 acts as a waveguide for light propagation.

Fiber core 38 is made of pure silicon dioxide, and fiber cladding 40 is fluorine doped as a single clad fiber sensing cable. Fiber core 38 may alternatively be F/GeO2 co-doped, with fiber cladding 40 being Fluorine-doped as a single clad fiber sensing cable. Fiber cladding 40 may be a double clad structure with a first clad lightly F-doped, and a second clad heavily Fluorine-doped. The fiber material, either pure silicon dioxide or co-doped tetrahedral O—Si—O structures, has Fluorine terminating all dangling bonds and eliminates the OH hydroxyl clusters to maintain the thermal stability and radiation resistance capability of the tetrahedral structure thermal stability.

A light source (such as in the FBG interrogator of FIG. 1), such as a tunable laser, a superluminescent, light-emitting diode (LED), and the like, is positioned in light emitting communication with optical fiber cable 32 and emits a near infrared light that propagates through fiber core 38. The light is transmitted or propagated through the fiber core 38 and into a photodetector or interrogator. Optical gamma thermometer 30 includes one or more fiber grating structures 42 that reflect light having a selected wavelength as the light is transmitted through the fiber core 38. Fiber grating structure 42 may include a fiber Bragg grating (FBG). The selected wavelength is determined by 2·n·A where the n is effective refractive index in the fiber core and the A is the grating modulation periodicity. The reflected light wavelength corresponds to a temperature of metal masses 34, 36. The reflected light signal is transmitted to the photodetector or interrogator (FIG. 1), where the light signal is processed and/or transmitted to a computer.

Each fiber grating structure 42 has a length along the long axis 33 of optical fiber cable 32 of about 5 millimeters to about 20 millimeters. In the case where fiber core 38 is made of pure silicon dioxide and fiber cladding 40 is a double clad structure, fiber grating structure 42 can be made from a pure quartz fiber inscribed with high-power femtosecond pulse laser grating inscription technology. Or fiber grating structure 42 may have a metalized cladding (not shown) surrounding fiber cladding 40 having a polycrystalline Al, Cu/Ni, or Au coating with a thickness of about 10-20 micrometer. In FIG. 2, optical gamma thermometer 30 includes two short-period fiber Bragg gratings (FBG) 42, but any number may be used. FBG 42 has an apodized refractive index modulation along the long axis 33 with a pitch size of about 0.5 microns.

FBG 42 is configured in a loose packaging arrangement to be effectively free from the effects of strain. In one embodiment, the length of fiber containing one or more FBGs 42 is packaged loosely in a structural cylinder, such that the outer diameter of fiber cable 32, typically 125 microns, is slightly less than the inner diameter of the structural cylinder, typically around 140 microns. Any strain induced on the package from the outside due to thermal gradients or the mass of the structure is accounted for in calibration and will not be considered FBG readings due to flux. In this way, the optical response of the FBGs will be limited to temperature effects and not strain effects. The optical fiber cable and FBGs 42 may also be coated with a thin layer of material, such as aluminum, to protect the fiber cable from damage within the structural cylinder. The strain effect on FBGs 42 due to differences in thermal expansion coefficients between the glass fiber and the cladding can be measured or calculated, and factored into the translation between optical wavelength shift and temperature.

Light is reflected at a single wavelength from FBG structures 42. The reflected signal is a function of material properties and grating structure, such as the index of refraction (n), the grating modulation number N, the normalized mode number V, the grating period A, and the grating length LG. The thermal induced wavelength shift, reflected power loss, and Bragg peak resonant width from the FBG 42 can be described as:

$$Δ λ ( T ) = {λ}_{B} ( \frac{1}{n} \frac{\partial n}{\partial T} + \frac{1}{Λ} \frac{\partial Λ}{\partial T} ) Δ T ;$$

$$R = {tanh}^{2} [ π \frac{Δ {nL}_{G}}{{λ}_{B}} ( 1 - \frac{1}{{V}^{2}} ) ] ;$$

$$Δ λ = {λ}_{B} \sqrt{{( \frac{Δ n}{2 n} )}^{2} + {( \frac{1}{N} )}^{2}}$$

The relative wavelength shift is proportional to gamma ray induced temperature change. The parameters

$$\frac{1}{n} \frac{\partial n}{\partial T}$$

$$and$$

$$\frac{1}{Λ} \frac{\partial Λ}{\partial T}$$

are thermo-optic coefficient and coefficient of thermal expansion, determined by the fiber material properties.

This background provides a useful baseline or starting point from which to better understand some example embodiments discussed below. Except for any clearly-identified third-party subject matter, likely separately submitted, this Background and any figures are by the Inventor(s), created for purposes of this application. Nothing in this application is necessarily known or represented as prior art.

### SUMMARY

Example embodiments include instrumentation including detectors that can detect and optically report temperatures, radiation levels, strain, seismic vibrations, water levels, and the like in challenging environments like operating power plants. Example embodiments may include arrays with a fiber-coated core that remain conductive of electromagnetic radiation at very high temperatures paired with a receiver that can detect and interpret the light conducted through the fiber. Example embodiments may use materials that generate and/or scatter light based on sensed phenomena, and, as such, may not require a thermal mass to generate heat based on detected phenomena like in related detectors. For example, pure or doped silica, silicon dioxide, quartz, acrylate, silicone, fluoropolymers, sapphire, as well as any combination of these materials may be used for fiber cores, claddings, and coatings. Impurities, voids, material variations, and dopants may include rare earth elements, halogens, boron, germanium oxides, carbon-doped aluminum oxide, etc. All these materials are resilient in high-temperature environments and report experienced physical phenomena like radiation fields, temperature, stresses in one or more dimensions, etc. through transmission of optical signals through the fiber array. Arrays may be used at multiple locations, including in vertical or axial spans of a nuclear reactor core, in coolant pools, and other locations, potentially in smaller areas that cannot accommodate thermal masses.

### BRIEF DESCRIPTIONS OF THE DRAWINGS

Example embodiments will become more apparent by describing, in detail, the attached drawings, wherein similar elements are represented by similar reference numerals. The drawings serve purposes of illustration only and thus do not limit example embodiments herein. Elements in these drawings may be to scale with one another and exactly depict shapes, positions, operations, and/or wording of example embodiments, or some or all elements may be out of scale or embellished to show alternative proportions and details.

FIG. 1 is an illustration of a related art system for measuring gamma flux.

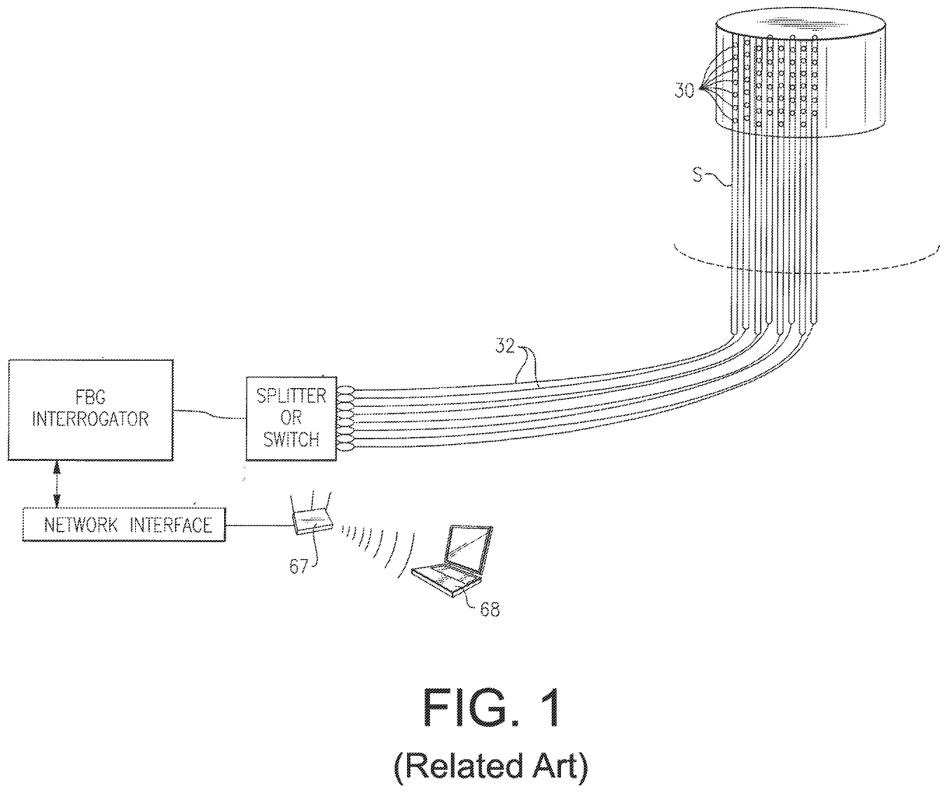

FIG. 2 is an illustration of a related art gamma thermometer string.

FIG. 3 is an illustration of an example embodiment sensor array.

FIG. 4 is an illustration of an example embodiment instrumentation system in use in a nuclear reactor.

### DETAILED DESCRIPTION

Because this is a patent document, general broad rules of construction should be applied when reading it. Everything described and shown in this document is an example of subject matter falling within the scope of the claims, appended below. Any specific structural and functional details disclosed herein are merely for purposes of describing how to make and use examples. Several different embodiments and methods not specifically disclosed herein may fall within the claim scope; as such, the claims may be embodied in many alternate forms and should not be construed as limited to only examples set forth herein.

Membership terms like “comprises,” “includes,” “has,” or “with” reflect the presence of stated features, characteristics, steps, operations, elements, and/or components, but do not themselves preclude the presence or addition of one or more other features, characteristics, steps, operations, elements, components, and/or groups thereof. Rather, exclusive modifiers like “only” or “singular” may preclude presence or addition of other subject matter in modified terms. The use of permissive terms like “may” or “can” reflect optionality such that modified terms are not necessarily present, but absence of permissive terms does not reflect compulsion. In listing items in example embodiments, conjunctions and inclusive terms like “and,” “with,” and “or” include all combinations of one or more of the listed items without exclusion of non-listed items. The use of “etc.” is defined as “et cetera” and indicates the inclusion of all other elements belonging to the same group of the preceding items, in any “and/or” combination(s). Modifiers “first,” “second,” “another,” etc. do not confine modified items to any order. These terms are used only to distinguish one element from another; where there are “second” or higher ordinals, there merely must be that many number of elements, without necessarily any difference or other relationship among those elements.

When an element is related, such as by being “connected,” “coupled,” “on,” “attached,” “fixed,” etc., to another element, it can be directly connected to the other element, or intervening elements may be present. In contrast, when an element is referred to as being “directly connected,” “directly coupled,” etc. to another element, there are no intervening elements present. Other words used to describe the relationship between elements should be interpreted in a like fashion (e.g., “between” versus “directly between,” “adjacent” versus “directly adjacent,” etc.).

As used herein, singular forms like “a,” “an,” and “the” are intended to include both the singular and plural forms, unless the language explicitly indicates otherwise. Indefinite articles like “a” and “an” introduce or refer to any modified term, both previously-introduced and not, while definite articles like “the” refer to the same previously-introduced term. Relative terms such as “almost” or “more” and terms of degree such as “approximately” or “substantially” reflect 10% variance in modified values or, where understood by the skilled artisan in the technological context, the full range of imprecision that still achieves functionality of modified terms. Precision and non-variance are expressed by contrary terms like “exactly.”

The structures and operations discussed below may occur out of the order described and/or noted in the figures. For example, two operations and/or figures shown in succession may in fact be executed concurrently or may be executed in the reverse order, depending upon the functionality/acts involved. Similarly, individual operations within example methods described below may be executed repetitively, individually or sequentially, so as to provide looping or other series of operations aside from exact operations described below. It should be presumed that any embodiment or method having features and functionality described below, in any workable combination, falls within the scope of example embodiments.

The inventors have recognized that optical fibers can withstand operating nuclear reactor conditions, including intense radiation and heat, while still remaining operable. Compared to conventional nuclear power sensors and monitors in use in commercial plants, optical-based signaling and fibers may require smaller amounts of space and no local power. Moreover, conventional sensors can typically sense only gamma flux in nuclear core locations. The Inventors have newly recognized that a variety of different interactions and sensor interpretation may be used with fiber optic cable, allowing a wide variety of light sources and characteristics sensed. Such optical methods may be used outside the core as well, potentially sensing several other conditions and phenomena inside or outside a nuclear core. To overcome these newly-recognized problems as well as others, the inventors have developed example embodiments and methods described below to address these and other problems recognized by the inventors with unique solutions enabled by example embodiments.

The present invention is optical sensors and systems using the same. In contrast to the present invention, the few example embodiments and example methods discussed below illustrate just a subset of the variety of different configurations that can be used as and/or in connection with the present invention.

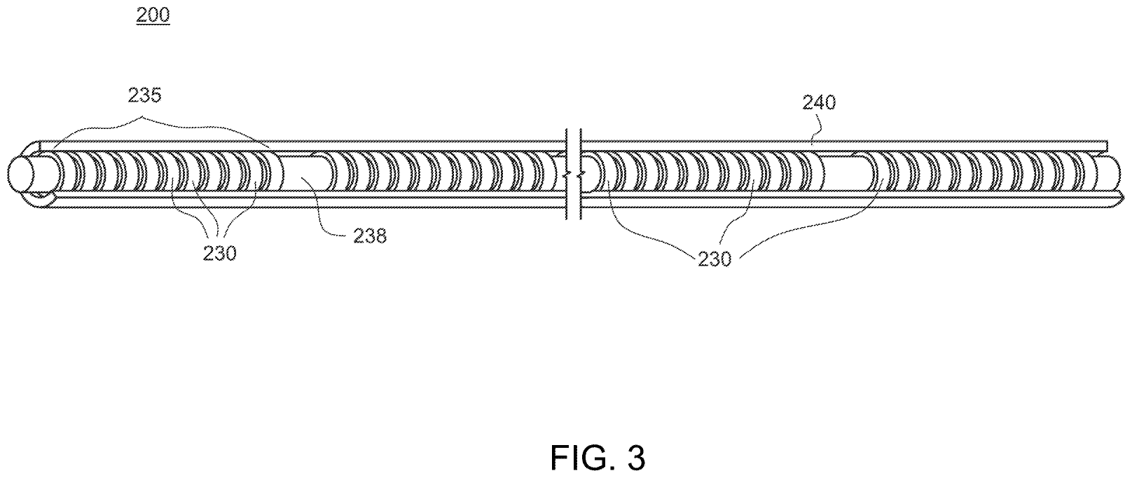

FIG. 3 is an illustration of an example embodiment sensor array 200, such as a gamma thermometer, useable in an operating nuclear reactor environment. Array 200 is fabricated of signal-carrying materials that are resilient when exposed to the high temperatures and radiation encountered in a nuclear reactor core, instrumentation tube, or similar environment. Sensor array 200 may include core 238 surrounded by cladding 240 that provides partial or complete reflection within core 238 for signal propagation, as well as carrying any material as a dopant, carrier, coating, etc. that permits measurement of desired phenomena, such as strain, radiation flux, etc. experienced by the materials. The materials maintain their physical properties in these challenging environments, except for detectable properties such as index of refraction, color, or strain, which may reversibly change in response to detected phenomena, such as gamma flux or temperature experienced by the materials. For example, fiber optic cable materials may be capable of transmitting light at temperatures of 1000° C. or more, in excess of those typically experienced in reactor cores.

For example, cable core 238 and cable cladding 240 may be fabricated of pure fuzed silica or doped silica, or core 238 could be silicon dioxide and cladding 240 could be quartz. Or, for example, cladding 240 could be acrylate or polyimide, which has a lower thermal mass and offers resilient mechanical protection. Cladding 240 may also be silicone, fluoropolymers, sapphire, as well as any combination of these materials. The dopant of any material may be a rare earth element or compound, a halogen such as fluorine, and/or boron. In the instance that radiation resistance or low cross-section is desired, any halogen dopant combination, including an iodine and/or bromine dopant, may be used to achieve a desired refractive index between core 238 and cladding 240. Any materials for core 238 and cladding 240 strongly resist damage from high-energy particles or quasi-particles, such as gamma-ray, neutrons, alpha and beta rays, etc.

For example, core 238 may be either pure silicon dioxide or doped silicon dioxide, and cladding 240 may be pure silicon dioxide if core 238 is co-doped with dopant such as F/GeO2 or doped with fluorine if core 238 is pure silicon dioxide. Or for example, core 238 may be pure silicon dioxide of 4-62.5 μm in diameter, and cladding 240 may be fluorine-doped silicon dioxide of 125 μm in diameter. Alternatively, cladding 240 may include two cladding structures, with a first cladding about 24-30 μm in diameter for single mode fiber and 82.5 μm in diameter for multimode fiber with light fluorine doping, and a second cladding out to a 125 μm diameter with a higher fluorine doping so that the refractive index profile of the fiber is reduced to values of 10e-4 to 10e-2 for reduced transmission loss.

Similarly, cladding 240 may be a thermo- or optically-stimulated luminescent detector material or be coated with such materials. Cladding 240 may include light-emitting materials such as carbon-doped aluminum-oxide that produce detectable and transmissible light at particular temperatures or when subject to particular levels of gamma flux. The light from the thermo- and optically-stimulated materials in A Gruel et al. “Gamma-heating and gamma flux measurements in the JSI TRIGA reactor, results and prospects,” 0018-9499 IEEE, 2019, incorporated by reference herein in its entirety, may be used for cladding 240 or as a coating on array 200 in example embodiments. Similarly, cladding 240 and/or core 238 may include materials, as dopants, coatings, or carriers, that produce detectable light scattering through Rayleigh, Raman, and/or Brillouin scattering, discussed below.

Core 238 may include perturbations 230 into cladding 240, such as crenulations or gratings, whose variation can be used to detect radiation and other physical interactions with array 200. For example, perturbations 230 may form fiber Bragg gratings along a length of core 238 with a known modulation period or pitch between perturbations 230. Any number of perturbations 230 may be used, and their relative positioning(s) may be known, to discriminate among physical phenomena, such as radiation interactions and/or temperature sensed by array 200. Similarly, core 238 and/or cladding 240 may include impurities, variations, and/or voids, either purposefully introduced or unavoidable in manufacturing, that cause light scattering that varies in determinable proportion to temperature or strain in core 238 or cladding 240.

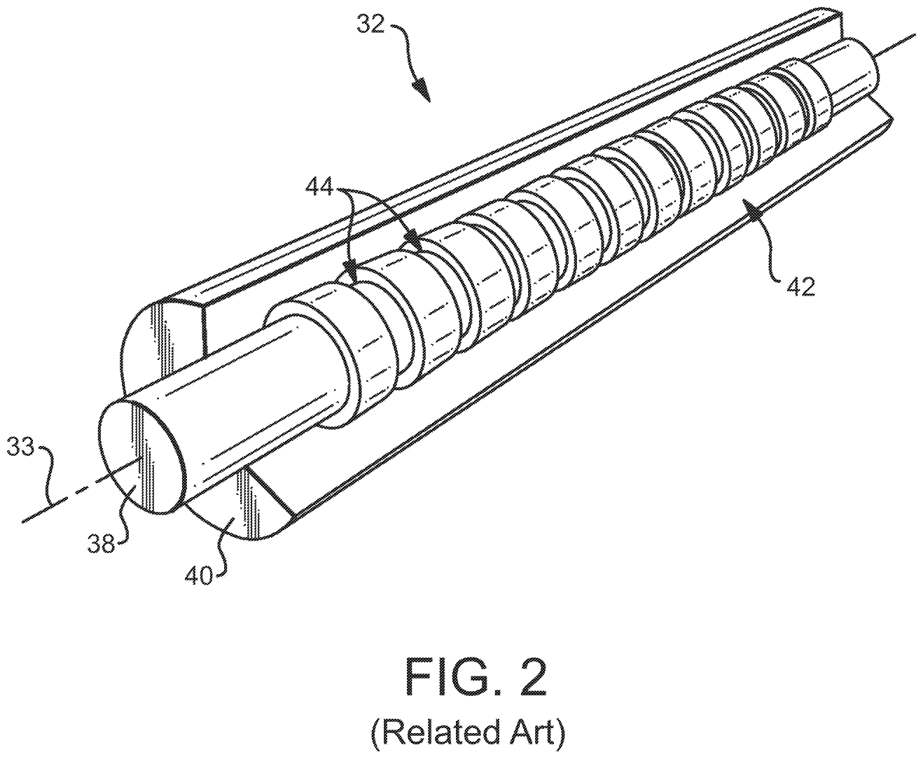

As shown in FIG. 2, perturbations 230 may be grouped together to form sensor 235 that is discrete, such as a single fiber Bragg grating sensor, with gaps between groups of perturbations 230 using an otherwise consistent core 238 and cladding 240. A series of perturbations 230 may require a centimeter or less of length of array 200 to form an operable fiber Bragg grating sensor. Any number of sensors 235 may be positioned along array 200, limited only by the total length of array 200. Each grouping of perturbations 230, such as a grating, forming sensor 235 may be distinctly configured to provide unique sensing and/or identification. For example, each sensor 235 may use a different grating modulation, or be configured with a different interference material, to interact with and/or reflect light of only particular frequencies, thus allowing identification and discrimination and/or filtering of different sensors 235 based on their unique outputs.

Cladding 240 may interact with perturbations 230, such as through expansion or stress changes, to produce detectable signals transmitted through fiber core 238. The thickness and material of cladding 240 may be selected based on expected physical conditions and the parameter to be sensed and reported. For example, cladding 240 may be about 50 microns to 900 microns thick. Thicker cladding 240 may be used for harsher environments with more radiation or higher mechanical stresses, and thinner cladding 240 may be used for lower signal attenuation, faster response to phenomena changes, especially in reactor time-constant requirements, and higher bandwidth or higher temperature environments. For example, a polyimide or acylate cladding 240 may be formed to any desired thickness through fiber manufacturing such as deposition or extrusion to coat and seal over and seamlessly in perturbations 230. No additional thermal mass may be required to heat or otherwise impact cladding 240 in response to sensed phenomena such as gamma flux. Cladding 240 itself, including a carrier, dopant, and/or coating material of cladding 240, changes in size, index of refraction, or other detectable property with respect to core 238, in response to change in temperature, gamma flux, and/or any other underlying sensed phenomena.

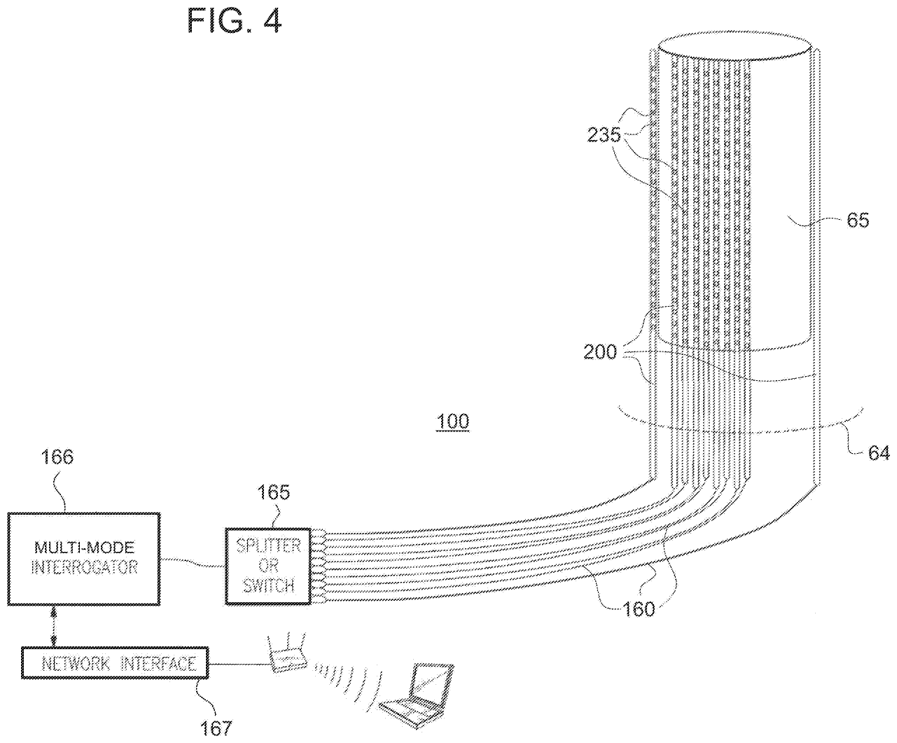

FIG. 4 is an illustration of an example embodiment sensor instrumentation system using one or more example embodiment arrays 200. As shown in FIG. 4, arrays 200 may be placed anywhere sensing is desired. For example, arrays 200 may extend throughout an axial height of core 65 including nuclear fuel in a nuclear reactor, potentially at dozens or even hundreds of radial locations across core 65. Or arrays 200 may extend outside of core 65, such as at other locations inside a pressure vessel or inside a containment building. Arrays 200 may be positioned inside sheaths or instrumentation tubes that may cross pressure boundary 64 to maintain any desired pressurization or containment and/or protect arrays from physical contact or other damage from surrounding structures.

Optical or other sensory connections 160 may communicatively connect arrays 200 with splitter 165 and/or interrogator 166 that converts energy from the arrays 200 from physical interactions detected into useable signals that reflect position, type, magnitude, timing, etc. of the detected phenomenon. For example, connections 160 may be fiber-optic cables that are continuations of core 238 (FIG. 3) and/or other optical cables or wires carrying the radiation from sensed interactions of sensors 235.

Splitter 165 or other signal isolator may receive connections 160 and segregate out responses from sensors 235 and/or remove noise received from array 200. For example, splitter 165 may isolate or filter signals from a subset or single sensor 235 along array 200 including multiple, potentially a hundred or more, sensors 235. Similarly, splitter 165 may isolate or filter signals from multiple arrays 200 among many connecting to splitter 165. In this way splitter or switch 165 may select out particular types of sensors 235, or a particular array or arrays 200, for signal reception by interrogator 166. Splitter 165 may further channelize or otherwise identify signals received from particular arrays 200 or sensors 235 such that interrogator 166 may receive a single input with signals already marked or otherwise shaped to indicate their origin, type, timing, etc. Of course, splitter or switch 165 may be absent or a configuration or module of interrogator 166 that may connect to all arrays 200.

Interrogator 166 may interpret a wide variety of signals from arrays 200 as physical phenomena sensed, corresponding to the physical characteristics of sensors 235 and the phenomena to which they are configured to detect. For example, scattering may be used by interrogator 166 to translate received signals into sensor data. Raman, Brillouin, and Rayleigh scattering, potentially using Stokes or anti-Stokes shifts, may be used to detect temperature and corresponding gamma flux detected by any sensor 235, discussed below.

Several different types of sensed phenomenon are detectable using Rayleigh scattering, including, temperature, pressure, stress, seismic, etc, based on strain and temperature effects on the optical fiber. For example, interrogator 166 may translate radiated outputs of arrays 200 into temperatures sensed by individual sensors 235 or array positions through Rayleigh scattering. Rayleigh scattering may result from density and composition variations in the material of arrays 200, including imperfections in fiber core 238 produced during manufacturing. Light from Rayleigh scattering may be distributed randomly along the whole length of array 200. This light, backscattered through array 200 to interrogator 166, from Rayleigh scattering from existing impurities or variations may be related to sensed phenomena. For example, an amount and type of light backscattered to interrogator 166 from Rayleigh scattering may correlate with strain and/or temperature in fiber core 238 with resolutions up to 1με and 0.1 0 C respectively. 1με is equal to 1 μm/m, or 10e-6 meters deformation per meter length.

Interrogator 166 may process the light with spatial resolution that allows for significant sensing distance. Spatial resolution of up to 20 microns can be achieved for a sensing distance up to 30 meters, with up to a sensing distance of 2 km possible before further resolution is not possible. Interrogator 166 may detect continuously-distributed strain along three different planes with different loading conditions in arrays 200. Interrogator 166 may further use optical time domain reflectometry (TDR) to differentiate between different sensors 235 or positions along array 200. For example, TDR can be used to identify inputs from sensors 235 at different axial height, allowing for water level monitoring in core 65 or another position, by detecting temperatures by height.

Similarly, several sensed phenomenon are detectable using Raman scattering, including, temperature, pressure, stress, seismic, etc, based on strain and temperature effects on the optical fiber. For example, interrogator 166 may translate radiated outputs of arrays 200 into temperatures sensed by individual sensors 235 or positions along array 200 through Raman scattering. The Raman effect occurs when light interacts with vibrational modes of molecules in materials forming core 238 and/or cladding 240. The light scattered back to interrogator 166 correlates to the molecular structure and temperature of the material. For example, Raman scattering can be used to measure material temperature changes in optical fiber-based gamma thermometry. When gamma radiation interacts with the material of core 238 and/or cladding 240, it produces a small amount of light due to Compton scattering. This light is then scattered through Raman scattering by interacting with molecular vibrations of the material. The frequency and intensity of the scattered light received by interrogator 166 can be correlated with temperature change in the material when adjusted for the refractive index of the fiber material and the molecular vibrations of the material.

Raman scattering may provide highly-accurate temperature measurements because Raman scattering is sensitive to temperature changes and has a narrow spectral linewidth, allowing for precise measurements. Raman scattering can also provide information about health of array 200, allowing degradation to be detected and monitored. Particularly, light transmitted from Raman scattering typically has a spectrum with peaks linearly related to material symmetry and structural properties of array 200. The peaks in the spectrum occur at intervals that depend on the physical characteristics of the optical phonon vibration, thus producing a fingerprint unique to that material. The interval may be the frequency shift from the optical phonon vibration modes and is related to the rotational and vibrational components of each phonon excitation energy at the time it encounters light. The frequency shift may appear as a positive shift (Stokes scattering) when the phonons receive energy and a negative shift (anti-Stokes scattering) when the phonons emit energy. The relative intensity of the Stokes and anti-Stokes peaks depends on the temperature of the optical phonon system, which follows a Boltzmann distribution.

Similarly, several sensed phenomenon are detectable using Brillouin scattering, including, temperature and mechanical properties based on acoustical properties on the optical fiber. For example, interrogator 166 may translate radiated outputs of arrays 200 into temperatures sensed by individual sensors 235 or positions along array 200 through Brillouin scattering. In Brillouin scattering, when gamma radiation interacts with materials of core 238 and/or cladding 240, it produces a small amount of light due to Compton scattering. Some of this light interacts with the acoustic phonons of the array material and undergoes Brillouin scattering. Interrogator 166 may then receive the scattered light to determine the temperature change in the material. Brillouin scattering takes into account several factors, including frequency and intensity of the incident light, the refractive index of the fiber material, and the acoustic phonons of the material.

Brillouin scattering can provide temperature and mechanical property measurements simultaneously because the frequency shift of the scattered light is related to the temperature of the material, while the linewidth of the scattered light is related to the mechanical properties of the material. Brillouin scattering may also provide accurate measuring of temperature and mechanical properties in materials that are difficult to measure using traditional methods. Because of its unique use of acoustic phonons.

As shown in FIG. 4, arrays 200 may be positioned within core 65 as well as outside core 65 at other reactor or plant positions. Arrays may detect and report characteristics other than gamma flux and thus reactor power level based on their positioning and configuration. For example, an array 200 placed in a plenum or downcomer may accurately report coolant level in a reactor pressure vessel by reporting temperatures at each height of sensors 235, with temperatures well above boiling indicating coolant level has dropped below the sensor measuring the same. Similarly, vibrations and physical pressures on fiber optic cables of array 200 may be used at other positions to detect seismic events and/or plant component failure from sensors 235. All these signals may be translated from light by interrogator and output to a plant operator through interface 167.

Some example embodiments and methods thus being described, it will be appreciated by one skilled in the art that examples may be varied through routine experimentation and without further inventive activity. For example, although commercial boiling water reactor systems are used in some example methods, it is understood that other plant types are useable with example embodiments and methods. Variations are not to be regarded as departure from the spirit and scope of the example embodiments, and all such modifications as would be obvious to one skilled in the art are intended to be included within the scope of the following claims.

1. An optical detector, comprising:
an optical array including,
a fiber core extending along an axis, and
a fiber cladding directly around the fiber core, wherein the fiber core and fiber cladding have melting points above 1000° C.; and
an interrogator in communication with the optical array and configured to translate energy from the optical array into sensed data, wherein the detector lacks a thermal mass associated with the optical array.

2. The detector of claim 1, wherein the fiber cladding includes at least one of acrylate, polyimide, silicone, fluoropolymers, a halogen, a rare earth element, carbon-doped aluminum oxide, and sapphire.

3. The detector of claim 1, wherein at least one of the fiber core and the fiber cladding are stimulated luminescent that emit light in response to temperatures and/or gamma radiation.

4. The detector of claim 3, wherein the stimulated luminescent includes carbon-doped aluminum oxide.

5. The detector of claim 1, wherein at least one of the fiber core and fiber cladding include materials that undergo Raman, Brillouin, or Rayleigh scattering dependent on at least one of temperature and gamma flux encountered.

6. The detector of claim 5, wherein the interrogator emits light into the optical array that is backscattered to the interrogator by the Raman, Brillouin, or Rayleigh scattering.

7. The detector of claim 1, wherein the fiber core includes perturbations extending into the cladding along the axis.

8. The detector of claim 7, wherein the optical array is configured to generate the energy from the perturbations through reflection of electromagnetic radiation from the interrogator.

9. The detector of claim 1, wherein the optical array is configured to emit the energy based on at least one of a temperature, radiation flux, and strain of the optical array.

10. An detector, comprising:
an optical array including,
a fiber core extending along an axis, and
a fiber cladding directly around the fiber core, wherein the fiber cladding includes at least one of acrylate, polyimide, silicone, fluoropolymers, carbon-doped aluminum oxide, and sapphire; and
an interrogator in communication with the optical array and configured to translate energy from the optical array into sensed data.

11. The detector of claim 10, wherein the fiber core and fiber cladding are doped with a halogen, a rare earth element, or fuzed silica.

12. The detector of claim 10, wherein at least one of the fiber core and the fiber cladding are stimulated luminescent that emit light in response to temperatures and/or gamma radiation.

13. The detector of claim 10, wherein at least one of the fiber core and fiber cladding include materials that undergo Raman, Brillouin, or Rayleigh scattering dependent on at least one of temperature and gamma flux encountered.

14. The detector of claim 13, wherein the interrogator emits light into the optical array that is backscattered to the interrogator by the Raman, Brillouin, or Rayleigh scattering.

15. The detector of claim 10, wherein the fiber core includes perturbations extending into the cladding along the axis.

16. The detector of claim 15, wherein the optical array is configured to generate the energy from the perturbations through reflection of electromagnetic radiation from the interrogator.

17. The detector of claim 10, wherein the optical array is configured to emit the energy based on at least one of a temperature, radiation flux, and strain of the optical array.

18. The detector of claim 10, wherein the detector lacks a thermal mass associated with the optical array.

19. A nuclear reactor comprising:
a reactor core housing nuclear fuel;
a reactor pressure vessel containing the reactor core and a reactor coolant; and
a plurality of optical arrays extending into the reactor core and completely apart from the reactor core, wherein each of the arrays include,
a fiber core extending along an axis, and
a fiber cladding directly around the fiber core, and wherein the fiber core includes perturbations extending into the cladding along the axis.

20. The nuclear reactor of claim 19, wherein the plurality of optical arrays lacks an associated thermal mass, the reactor further comprising:
an interrogator in communication with the optical array and configured to translate energy from the optical array into sensed data.
